(19) United States
(12) Patent Application Publication
(10) Pub. No.: US 2024/0163260 A1
(43) Pub. Date: May 16, 2024

(54) PERSISTENT DATA SECURITY FOR DATA PROCESSING UNITS

(71) Applicant: VMware, Inc., Palo Alto, CA (US)

(72) Inventors: Andrei Warkentin, South Elgin, IL (US); Adithya Uligere Narasimhamurthy, Longmont, CO (US); Alexander Fainkichen, Southborough, MA (US); Jared McNeil, Quispamsis (CA)

(21) Appl. No.: 17/984,419

(22) Filed: Nov. 10, 2022

(51) Int. Cl. H04L 9/40; G06F 21/57

(52) U.S. Cl. CPC H04L 63/0428; G06F 21/572; G06F 2221/034

(57) ABSTRACT

Systems and methods are described for secure management of a data processing unit (“DPU”). In an example, a baseboard management controller (“BMC”) can provision a DPU. Provisioning can include configuring a local storage device for DPU storage and locking access to the DPU storage with an encrypted access key. To boot the DPU, the BMC can initiate DPU firmware on the DPU. The DPU firmware can retrieve the access key from the BMC and unlock the DPU storage with the access key. The DPU firmware can be configured to then delete the access key. Once the DPU storage is unlocked, the DPU firmware can load an operating system of the DPU. The BMC can be the only entity that retains the access key. To perform a secure wipe, instructions can be provided to the BMC to delete the access key, which renders the DPU storage and all data therein inaccessible.

### BACKGROUND

Many datacenters have begun using data processing units (“DPUs”) to increase data processing speeds. A DPU is a controllable device, such as a system on a chip (“SoC”), with hardware acceleration of data processing for data-centric computing. A DPU is generally installed on a physical server and operates in isolation of the server's central processing unit (“CPU”). The DPU offloads network interface data processing workloads from the CPU so that high performance network interfaces can process data at much faster rates

In part because the DPU operates independently of the CPU, the DPU may be required to maintain a persistent state on a local storage device. Some DPU data can include potentially sensitive client data. This creates challenges related to handling the security of DPU data. For example, one method of executing a secure wipe of a DPU include instructing the DPU's operating system (“OS”) to erase itself and all DPU data. However, this method relies on the DPU OS functioning correctly and passing integrity checks. If the DPU OS is not functioning correctly or does not pass integrity checks, then there is no way to prove that the DPU OS actually executed the security wipe. Also, secure wipes can take a significant amount of time to execute, and they can be interrupted by removing the power from the server or physically removing the DPU. This can potentially expose sensitive DPU data to a malicious actor.

As a result, a need exists for securing persistent data related to DPUs.

### SUMMARY

Examples described herein include systems and methods for providing secure management of a DPU. DPU data can be secured by locking access to DPU data using an encrypted access key, and the encrypted access key is only persisted by a baseboard management controller (“BMC”) that provisions the DPU and provides the encrypted access key to the DPU every time the DPU boots. In an example, the BMC can provision the DPU on a server. Provisioning the DPU can include configuring a location storage device, or a portion of a local storage device, for DPU storage. DPU storage can include the DPU OS and any DPU-related data, such as client and workload data. Provisioning the DPU can also include generating an encrypted access key (referred to interchangeably as “access key”). The access key can be randomly generated, such as by using a random bit generator (“RBG”) that generates a sequence of unpredictable and unbiased bits. The BMC can encrypt the access key using any appropriate cryptographic algorithm.

In one example, the DPU storage can be configured on a local storage device that supports access restrictions with an encrypted access key, where the BMC can lock access to the DPU storage with the access key. The BMC can configure the DPU firmware to retrieve the access key each time the DPU storage needs to be unlocked, and the BMC can be configured to only provide the access key to the DPU firmware. For example, when the server boots up, the BMC can initiate the DPU firmware. The DPU firmware can retrieve the access key from the BMC and unlock the DPU storage. Once the DPU storage is unlocked, the DPU firmware can be configured to delete the access key. The DPU firmware can then boot the DPU OS. The DPU firmware must retrieve the access key every time the DPU storage needs to be unlocked, such as after the server boots up or restarts.

Initiating a secure wipe includes sending instructions to the BMC to delete the access key. Once deleted, the access key is unrecoverable because it was randomly generated and only persisted at the BMC. Deleting the access key therefore renders the DPU storage inaccessible. Ensuring that a secure wipe was properly executed does not rely on the DPU OS operating correctly or passing security checks. The DPU data is also protected even if the local storage device or DPU SoC is physically stolen because access to the DPU data is locked by an access key that only exists at the BMC. Initiating a secure wipe can also include shutting down or restarting the DPU, or the entire server, after the access key is deleted. Restarting the DPU or the server eliminates access that the current instance of the DPU OS has to the DPU data. The DPU firmware is then unable to access the DPU storage to boot the DPU OS again because the access key no longer exists.

In one example, the DPU storage can be configured on a local storage device that does not support access restrictions with an encrypted access key, such as remote block-level storage like Internet Small Computer Systems Interface (“iSCSI”). In such an example, the DPU OS can be temporarily entrusted with the access key. The DPU OS, after its initial boot, can encrypt access to the DPU data using the access key. When booting the DPU, the BMC can initiate the DPU firmware and provide the access key to the DPU firmware. The DPU firmware can initiate a boot loader that loads the DPU OS. Once loaded, the DPU OS can be configured to retrieve the access key from the DPU firmware. The DPU OS can unlock the DPU data and then delete the access key. The DPU firmware can also be configured to delete the access key after providing the access key to the DPU OS. This method can require that the DPU firmware verify that the DPU OS passes integrity checks before providing the access key.

In the example above, even though the DPU OS is entrusted with the access key, performing a secure wipe does not require that the DPU OS perform a secure boot or pass integrity checks. The secure wipe can still be performed by simply deleting the encryption key at the BMC. For example, if the BMC initiates the DPU firmware and the DPU firmware boots the DPU OS, then the DPU OS cannot access any of the DPU data because access to the DPU data is locked by an access key that no longer exists.

In one example, the DPU storage can be configured on a removeable media card, such as an embedded multi-Media Card (“eMMC”) or a Secure Digital (“SD”) card. In such an example, the BMC can configure the DPU firmware to check the media card for access protections. For example, when the DPU firmware is initiated, the DPU firmware can determine whether the media card with the DPU storage is locked. If not, the DPU firmware can create an access password using the access key from the BMC. As an example, the DPU firmware can set the password using a CMD42 SET_PWD command. If the media card is locked, then the DPU firmware can simply unlock the media card using the access key from the BMC. The DPU firmware can delete the access key after setting the password or unlocking the media card with the access key.

The media card can be configured to automatically lock when removed from the server. Inserting the media card into a different computing device does not expose the DPU data because access to the media card is locked by an access key that only persists at the BMC and can only be accessed while the media card is connected to the server. Also, a secure wipe can still be executed by simply deleting the access key at the BMC.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for providing secure management of a DPU.

FIG. 2 is a sequence diagram of an example method for providing secure management of a DPU.

FIG. 3 is another sequence diagram of an example method for providing secure management of a DPU.

FIG. 4 is another sequence diagram of an example method for providing secure management of a DPU.

FIG. 5 is another sequence diagram of an example method for providing secure management of a DPU.

FIG. 6 is an illustration of an example system for performing providing secure management of a DPU.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for secure management of a DPU. In an example, a BMC can provision a DPU. Provisioning can include configuring a local storage device for DPU storage and locking access to the DPU storage with an encrypted access key. To boot the DPU, the BMC can initiate DPU firmware on the DPU. The DPU firmware can retrieve the access key from the BMC and unlock the DPU storage with the access key. The DPU firmware can be configured to then delete the access key. Once the DPU storage is unlocked, the DPU firmware can load an operating system of the DPU. The BMC can be the only entity that retains the access key. To perform a secure wipe, instructions can be provided to the BMC to delete the access key, which renders the DPU storage and all data therein inaccessible.

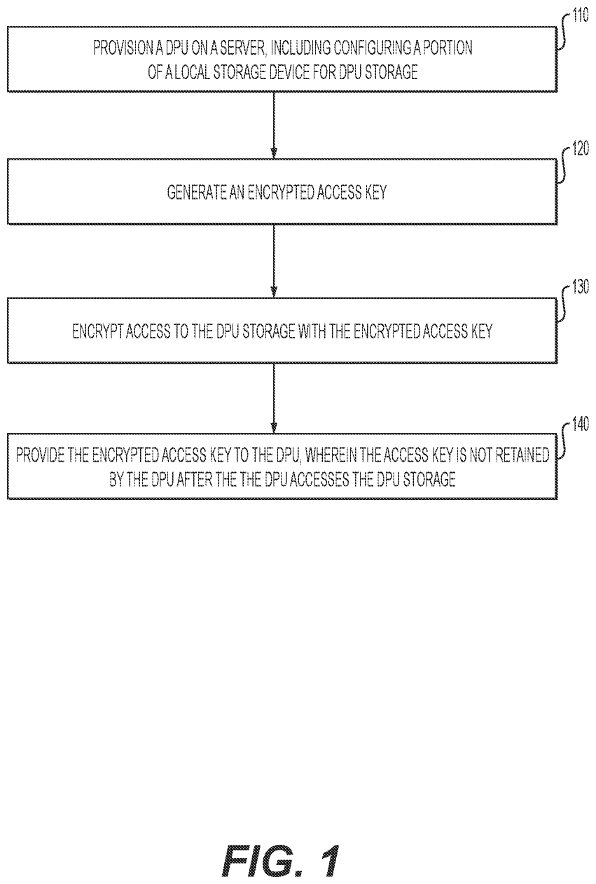

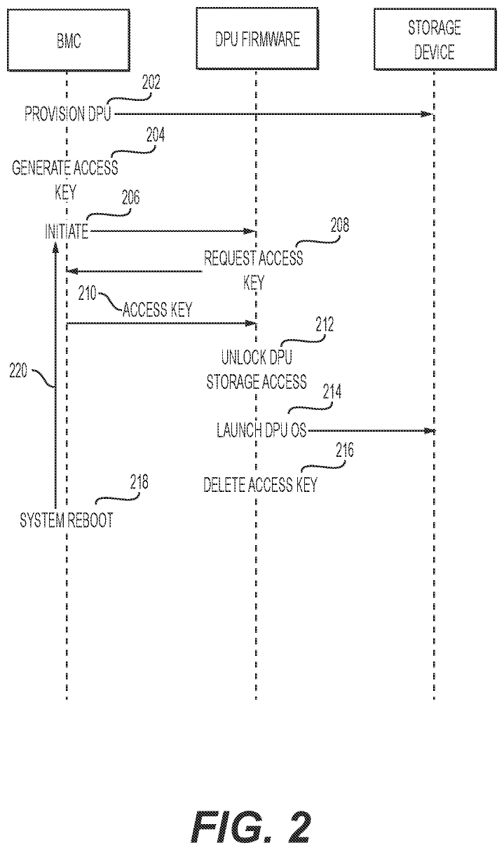

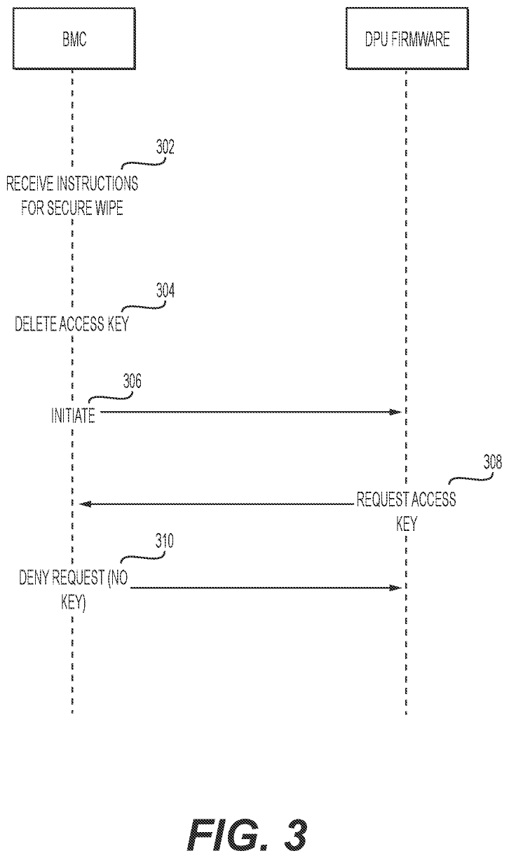

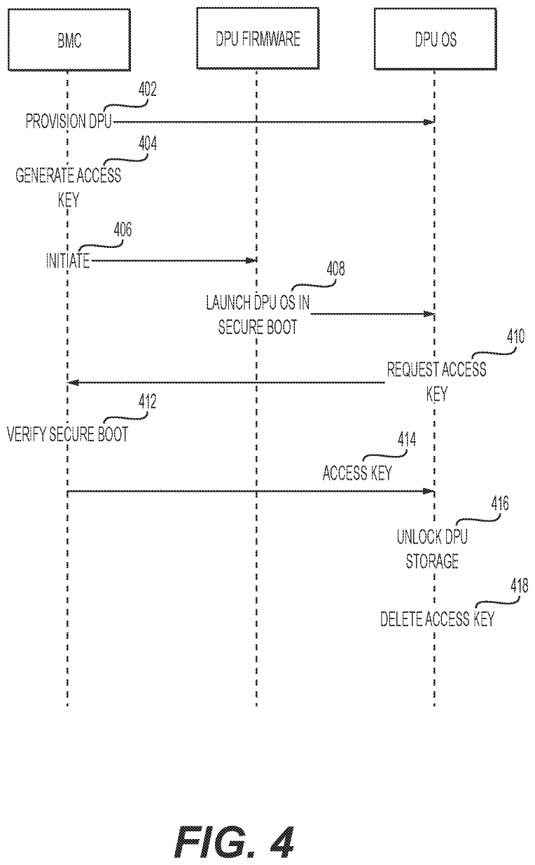

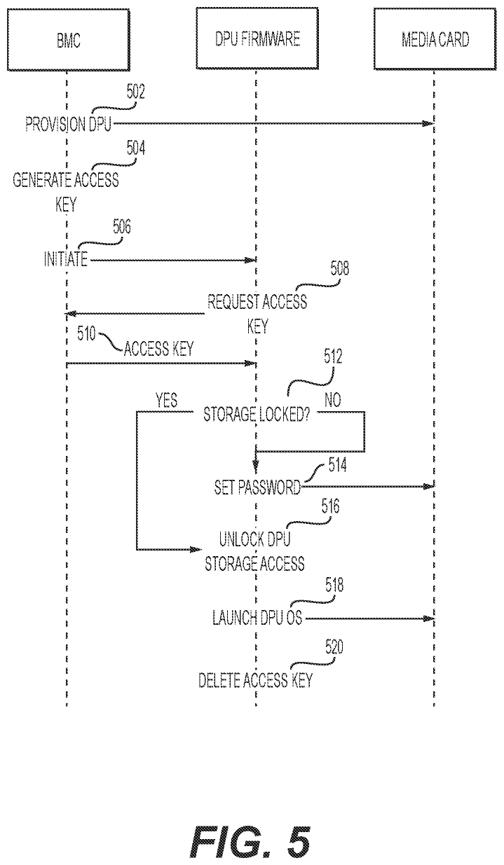

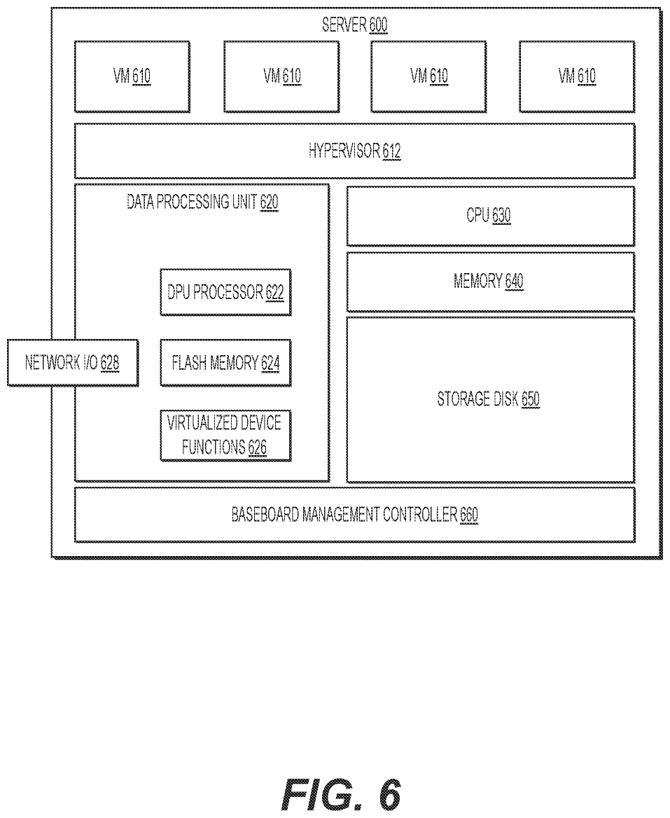

FIG. 1 is a flowchart of an example method for providing secure management of a DPU where the DPU OS is provisioned on a local storage device that supports access restrictions with an encrypted access key. FIG. 2 is a sequence diagram of the example method described in FIG. 1. FIG. 3 is a sequence diagram of an example method for performing a secure wipe of a DPU. FIG. 4 is a sequence diagram of an example method for providing secure management of a DPU where the DPU OS is provisioned on a storage device that does not support access restrictions with an encrypted access key. FIG. 5 is a flowchart of an example method for providing secure management of a DPU where the DPU OS is provisioned on a removeable media card. FIG. 6 is an illustration of an example system for performing providing secure management of a DPU.

FIG. 1 is a flowchart of an example method for providing secure management of a DPU. At stage 110, a BMC can provision a DPU on a server. The BMC can be a specialized service processor that manages an interface between system-management software and platform hardware. A DPU can be a controllable device, such as a SoC, with hardware acceleration of data processing for data-centric computing. In an example, the DPU can be a network interface controller (“NIC”) or SmartNIC that can be plugged into a server.

Provisioning the DPU can include the steps required to manage access to the DPU and to make the DPU available to users and systems. This can include all of the operations needed to bring the DPU to a working state, such as by installing an OS of the DPU, defining the desired state of the DPU, and configuring the DPU to communicate with other components of the server, such as the CPU, memory, hard disk storage, and any virtual components like virtual machines (“VMs”).

At stage 120, the BMC can generate an encrypted access key. This can be part of the provisioning process. The encrypted access key (referred to interchangeably as simply the “access key”) can be an encryption key used for accessing DPU storage. As used herein, the term “encryption key” can refer to a piece of information, such as a string of numbers and/or letters, that are stored in a file, which, when processed through a cryptographic algorithm, can encode or decode cryptographic data. The encrypted access key can be randomized, such as by using an RBG that generates a sequence of unpredictable and unbiased bits. In an example, the encrypted access key can be a symmetric encryption key. In some examples, the access key is generated as the output of a hash function.

The BMC can retain the encrypted access key in a secure storage location that is inaccessible to any external entity except for the DPU. Furthermore, the BMC can be configured to only provide the access key to the DPU using a trusted communication channel between the BMC and the DPU, such as with a network controller sideband interface (“NC-SI”) protocol or an Inter-Integrated Circuit (“I2C”) serial communication bus. The BMC can also be configured to encrypt the access key before providing it to the DPU. The BMC can encrypt the access key using any available encryption method, such as an asymmetric key pairing using a public key provided by the DPU.

At stage 130, the BMC can encrypt access to the DPU storage with the encrypted access key. This can also be part of the provisioning process. For example, the BMC can create a persistent installation of the DPU OS on a storage component. In one example, the DPU OS can be installed locally on the SmartNIC card of the DPU, such as a flash memory. Alternatively, the DPU OS can be installed on a storage drive of the server, such as a hard disk drive (“HDD”) or a solid-state drive (“SSD”). Other data for the DPU OS can be stored with the DPU OS, such as client data and VM workload data. The DPU can include firmware that is responsible for booting the DPU OS. The BMC can encrypt access to the DPU storage with the DPU OS and data so that the DPU firmware cannot access the DPU storage to initiate booting of the DPU OS without first obtaining the encryption key from the BMC.

At stage 140, the BMC can provide the encrypted access key to the DPU. For example, the BMC can initiate the DPU firmware. This can occur after the DPU is provisioned or after any subsequent boot or reboot of the server. The DPU firmware can be configured to request the access key from the BMC before initiating the DPU OS. The BMC can provide the access key in response to a query from the DPU firmware. The DPU firmware can then unlock access to the DPU storage with the access key. Once unlocked, the DPU firmware has access to the DPU storage and can initiate the DPU OS.

After unlocking access to the DPU storage, the DPU firmware can delete the access key. The access key is then only retained at the BMC. The DPU firmware can be required to retrieve the access key from the BMC every time it needs to unlock the DPU storage. This can protect sensitive DPU data, such as client data, from malicious entities. For example, unlocking the DPU storage can unlock access to the DPU storage for only the entity that provided the access key. Other entities must also provide the access key to unlock access to the DPU storage. However, because only the BMC retains the access key, the BMC is configured to only provide the access key to the DPU firmware, and the DPU firmware deletes the access key after unlocking access, other entities are unable to obtain the access key.

The method described above simplifies the execution of security protocols related to the DPU. For example, when executing a security wipe of the DPU data, an organization can simply instruct the BMC to delete the access key. The DPU data, including the DPU OS and any client and workload data, is protected by the encrypted access, and not accessible even by the DPU firmware. Because the access key is randomized, it cannot be reproduced or obtained from another location. By deleting the key at the BMC, the DPU enters a greenfield state and further use requires a reprovisioning of the DPU. Even if the DPU OS and DPU data are stored on the DPU's SmartNIC, a malicious actor could not access the data by stealing the SmartNIC because the access key is securely stored at the BMC.

FIG. 2 is a sequence diagram of an example method for providing secure management of a DPU. At stage 202, a BMC can provision a DPU on a server. Provisioning the DPU can include installing a DPU OS on a local storage device. The storage device can be a flash memory component of the DPU's SmartNIC or, alternatively, a storage component of the server, such as an HHD or SSD. The DPU firmware can persist on the flash memory of the DPU SmartNIC. The portion of the storage dedicated to the DPU OS and DPU data, such as client and workload data, is referred to hereinafter as the “DPU storage.”

At stage 204, the BMC can generate an encrypted access key. The encrypted access key can be an encryption key used for accessing DPU storage. The encrypted access key can be randomized, such as by using an RBG that generates a sequence of unpredictable and unbiased bits. The encryption key can be symmetric so that the BMC can provide the encryption key to DPU firmware and the DPU firmware can use the same encryption key to unlock access to the DPU storage. In some examples, the encrypted access key is generated by first generating a random string of characters and then feeding that string of characters through a hash function to encrypt it.

The BMC can retain the encrypted access key in a secure storage location that is inaccessible to any external entity except for the DPU. The BMC can also be configured to only provide the access key to the DPU using a trusted communication channel between the BMC and the DPU, such as with an NC-SI protocol or an I2C serial communication bus.

At stage 206, the BMC can initiate the DPU firmware. For example, the BMC can execute a string of code that causes the DPU firmware to initiate a boot sequence. As part of the boot sequence, at stage 208 the DPU firmware can request the access key from the BMC. At stage 210, the BMC can respond to the request by providing the access key to the DPU firmware.

At stage 212, the DPU firmware can unlock access to the DPU storage using the access key. The DPU storage can be configured to allow access only to entities that provide the access key, so even though the DPU storage is unlocked, only the DPU firmware can access the data therein. At stage 214, the DPU firmware can launch the DPU OS. For example, the DPU firmware can execute a string of code that causes an OS loader (e.g., a kernel) to begin executing and load the DPU OS.

At stage 216, the DPU firmware can delete the access key. The access key is then only retained at the BMC, and the DPU firmware must re-obtain the access key whenever the DPU firmware needs to unlock the DPU storage, such as when the server reboots. In an example, stage 216 can occur before stage 214. For example, the DPU firmware can delete the access key after unlocking access to the DPU storage and before launching the DPU OS. At stage 218, the server can reboot. The reboot can include any action that causes the DPU firmware to lose access to the DPU storage, such as the server powering down and powering back on, a full system reboot, or a reboot of just the DPU OS.

At stage 220, the method can return to stage 206 where the BMC can initiate the DPU firmware, and the DPU firmware can re-obtain the access key for unlocking the DPU storage and launching the DPU OS. Every time the DPU firmware obtains the access key, the DPU firmware can delete the access key after unlocking the DPU storage. The BMC is then the only location where the access key persists.

FIG. 3 is a sequence diagram of an example method for performing a secure wipe of a DPU. At stage 302, the BMC can receive instructions to perform a secure wipe. In one example, the instructions can originate from an administrator (“admin”) user. For example, an admin user, using an admin console or interface, can send instructions to deprovision the DPU. Alternatively, a security and monitoring entity of a system can identify a threat to the DPU, such as a security breach, malware executing on the server, or abnormal behavior by the DPU OS. Such a security and monitoring entity can be an application, service, or software that monitors the server and/or a system that the server is a part of. The security and monitoring entity can be configured with security protocols that cause the security and monitoring entity to perform certain security actions in response to detected threats and abnormalities. For example, in response to a detected threat and abnormality at the server or the DPU, the security and monitoring entity can instruct the BMC to perform a secure wipe of the DPU.

At stage 304, the BMC can delete the access key. Because the BMC is the only location where the access key persists, deleting the access key renders the DPU storage inaccessible. Also, because the access key is randomly generated and therefore unique to the DPU, the DPU storage cannot be accessed by connecting a different BMC or migrating the DPU to another server. Migrating the DPU to another server automatically places the DPU into a greenfield/unprovisioned state.

At stage 306, the BMC can initiate the DPU firmware. For example, the BMC can execute a string of code that causes the DPU firmware to initiate a boot sequence. As part of the boot sequence, at stage 308 the DPU firmware can request the access key from the BMC. However, because the BMC deleted the access key at stage 304, the BMC can deny the request at stage 310 because the access key no longer exists.

Executing a secure wipe can include additional actions. For example, in addition to deleting the access key, a security wipe can include any actions that remove or cease any operations executing at the DPU storage or that reset access to the DPU storage. In one example, the DPU OS can be instructed to wipe itself. Alternatively, or in an instance where the DPU OS does not properly respond to wipe instructions, the server can receive instructions to shut down or reboot. As described previously, a shut down or reboot of the server can reset the DPU firmware's access to the DPU storage. Deleting the access key and rebooting the server can make the DPU storage unreadable by any entity. Restarting or shutting down the server can have the added benefit of stopping the current iteration of the DPU OS from running. Although other secure wipe actions can be implemented, such as by instructing the DPU OS to erase itself, deleting the security key and restarting or shutting down the server can ensure that the DPU storage is unreadable.

FIG. 4 is another sequence diagram of an example method for providing secure management of a DPU where the DPU OS is installed on a storage component that does not support access restrictions with an encrypted access key, such as a remote block-level storage like iSCSI. The DPU firmware can persist on a storage component of the DPU SoC, such as a flash memory. At stage 402, a BMC can provision a DPU using a storage component that does not support access restrictions using an encrypted access key. Provisioning the DPU can include the steps required to manage access to the DPU and to make the DPU available to users and systems. This can include, for example, installing the DPU OS.

Particularly when the DPU OS is installed on a storage device that does not support access restrictions with an encrypted access key, the BMC can configure the DPU firmware to boot the DPU OS in a secure boot mode. A secure boot establishes trust between the DPU firmware and the DPU OS using signed asymmetric key pairings. The DPU firmware is configured to only execute boot code that has a valid, signed certificate. This prevents illicit software from taking control of the DPU at startup.

The DPU OS can be installed on a separate portion of the storage device than other DPU data. The DPU OS can be installed on a portion of the storage device without access restrictions, and the non-OS DPU data can be stored on a portion that is locked by the access key. This allows the DPU firmware to launch the DPU OS while access to potentially sensitive DPU data is protected by the access key. In one example, the BMC can configure the DPU OS and non-OS portions of the storage. Alternatively, the BMC can configure the DPU OS portion of the storage, and the DPU OS can configure the non-OS portion and encrypt access to the non-OS DPU data after its first boot.

At stage 404, the BMC can generate an access key. The encrypted access key can be an encryption key used for accessing DPU storage. The encrypted access key can be randomized, such as by using an RBG that generates a sequence of unpredictable and unbiased bits. The encryption key can be symmetric so that the BMC can provide the encryption key to DPU firmware and the DPU firmware can use the same encryption key to unlock access to the DPU storage.

At stage 406, the BMC can initiate the DPU firmware. For example, the BMC can execute a string of code that causes the DPU firmware to initiate a boot sequence. At stage 408, the DPU firmware can launch the DPU OS in a secure boot mode. For example, the DPU firmware can be configured to execute a particular string of code for initiating an OS loader (e.g., a kernel). Before executing the OS loader code, the DPU firmware can verify that the OS loader code is signed with a valid certificate, thereby ensuring that the proper OS is loaded.

At stage 410, the DPU OS can request the access key from the BMC. If the DPU is hosted remotely, the DPU OS can make the request using any appropriate communication protocol, such as an application programming interface (“API”) call. At stage 412, the BMC can verify that the DPU OS is properly booted in secure boot mode. For example, the BMC can query the DPU firmware, and the DPU firmware can confirm that the DPU OS loaded in secure boot mode. At stage 414, the BMC can provide the access key to the DPU OS. If the DPU OS is installed on a storage device separate from the BMC and the DPU firmware, the BMC can first encrypt the access key, such as with an encryption key pairing. In some examples, the DPU OS can obtain the access key from the BMC through the DPU firmware. For example, the DPU firmware can request the access key and then provide the access key to the DPU OS.

At stage 416, the DPU OS can unlock access to the DPU storage. In one example, on its first boot, the DPU OS can encrypt access to the DPU storage using the access key. The DPU OS can then unlock access to the DPU storage with the access key on subsequent boots. The DPU OS can then delete the access key at stage 418. If the DPU itself, the server that the DPU SmartNIC is installed on, or the DPU OS, reboots, at stage 420 the method can return to stage 406 where the BMC again initiates the DPU firmware.

FIG. 5 is another sequence diagram of an example method for providing secure management of a DPU where the DPU OS is installed on a removeable media card, such as an eMMC or an SD card. The DPU firmware can persist on a storage component of the DPU SoC, such as a flash memory. At stage 502, a BMC can provision a DPU on the media card. Provisioning the DPU can include installing the DPU OS on the media card and configuring the DPU firmware to boot the DPU OS from the media card. The BMC can configure the DPU firmware to perform certain security checks on the media card to ensure that the media card is locked. These security checks are described at stages 512, 514, and 516 below.

At stage 504, the BMC can generate an encrypted access key. The encrypted access key can be an encryption key used for accessing DPU storage. The encrypted access key can be randomized, such as by using an RBG that generates a sequence of unpredictable and unbiased bits. The encryption key can be symmetric so that the BMC can provide the encryption key to DPU firmware and the DPU firmware can use the same encryption key to unlock access to the DPU storage.

At stage 506, the BMC can initiate the DPU firmware. For example, the BMC can execute a string of code that causes the DPU firmware to initiate a boot sequence. As part of the boot sequence, at stage 508 the DPU firmware can request the access key from the BMC. At stage 510, the BMC can respond to the request by providing the access key to the DPU firmware.

At stage 512, the DPU firmware can determine whether the media card is locked. For example, the DPU firmware can determine whether a password or access key is required to access the DPU storage on the media card. If the media card is not locked, then at stage 514 the DPU firmware can set a password for the media card using the access key. For example, the DPU firmware can set the password using a password setting mechanism for media cards like CMD42. As an example, the DPU firmware can run CMD42 SET_PWD on the media card and use the access key for the password. If the media card is locked at stage 512, then at stage 516 the DPU firmware can unlock access to the media card with the access key. As an example, the DPU firmware can use the CMD42 command with the access key to unlock the media card. Once the media card is unlocked, at stage 518 the DPU firmware can initiate the DPU OS from the media card. For example, the DPU firmware can execute a string of code that causes an OS loader (e.g., a kernel) to begin executing and load the DPU OS.

At stage 520, the DPU firmware can delete the access key. The access key is then only retained at the BMC, and the DPU firmware must re-obtain the access key whenever the DPU firmware needs to unlock the DPU storage, such as when the server reboots or the media card is removed and re-inserted into the server. The media card can only be unlocked with the access key retained by the BMC that generated the access key. As a result, if the media card is removed from the server and inserted into a different computing device, then the different computing device would not be able to unlock the media card and access the DPU storage stored thereon.

FIG. 6 is an illustration of an example system for performing providing secure management of a DPU. A server 600 can host one or more VMs 610. The server 600 can be a physical computing device with computing resources that software running on the server can utilize. Examples of computing resources can include processing power, storage, network connectivity, and the like. Processing power can be provided by a CPU 630. Storage can be provided by a memory 640 and a storage disk 650. The memory 640 can be short-term memory where the data that the CPU 630 is currently using is stored, such as random-access memory (“RAM”). The storage disk 650 can be a data storage device where data is persisted until deleted or overwritten, such as an HDD or SSD.

The VMs 610 can be software running on the server 600 that run programs and deploy apps. The VMs 610 can be managed by a hypervisor 612. The hypervisor 612 can be software that creates and runs virtual machines. Execution of the hypervisor 612 and VMs 610 can be handled by the CPU 630 and memory 640.

The server 600 can include a DPU 620 that handles network and data management tasks. The DPU 620 can be a controllable device, such as an SoC, with hardware acceleration of data processing for data-centric computing. As some examples, the DPU 620 can be a NIC or SmartNIC. The DPU 620 can include a DPU processor 622, flash memory 624, virtualized device functions 626, and a network input/output (“I/O”) 628. The DPU processor 622 can run network and storage services for the server 600 in isolation from the CPU 630. The flash memory 624 can be a form of non-volatile computer memory storage medium (“NVM”) that can be electrically erased and reprogrammed. Firmware for the DPU can be stored on the flash memory 624.

The virtualized device functions 626 can be virtualized devices that appear to the hypervisor 612 as a hardware device. Some examples of virtualized device functions 626 can include NVM Express (“NVMe”), virtual network adapters, and Peripheral Component Interconnect Express (“PCIe”). The network I/O 628 can be any kind of network component for connecting the server to a computer network. Some examples of a network I/O 628 can include XFP transceivers for optical fibers and small form-factor pluggable transceivers (“SFP”) like an RJ45 connector.

The server 600 can include a BMC 660. The BMC 660 can be a specialized service processor that manages an interface between system-management software and platform hardware of the server 600. The BMC 660 can provision the DPU 620 at the server 600. The provisioning can include installing an OS for the DPU 620. The provisioning can also include configuring a storage device for storing the DPU OS and DPU-related data, such as client and workload data. The BMC 660 can lock access to the DPU storage using a randomly generated encrypted access key that the BMC 660 generates. The BMC 660 can also install the DPU OS on the storage device, which can be the storage disk 650, a remote block-level storage like an iSCSI, a removeable media card, or another type of storage device. The BMC 660 can retain the encryption key in a secure location that cannot be accessed by any other entity. The BMC 660 can be configured to provide the encrypted access key to only the DPU firmware or the DPU OS, depending on the type of storage device that the DPU OS runs on.

The encrypted access key generated by the BMC 660 can be visible only to the DPU 620. The BMC 660 can provide the encrypted access key to the DPU 620 using a trusted communication channel. Some examples of trusted communication channels can include using an I2C serial communication bus or a private link that uses NC-SI protocols or a REDFISH API. The BMC can also exchange other communications with the firmware of the DPU 620 using the same trusted communication channel.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather, any feature of any example described here can be incorporated into any other suitable example. It is intended that the specification and examples be considered as exemplary only, with a true scope and spirit of the disclosure being indicated by the following claims.

What is claimed is:

1. A server, comprising:
a central processing unit (“CPU”);
a data processing unit (“DPU”) having a processor and a memory storage, the memory storage including a non-transitory, computer-readable medium, wherein a DPU firmware persists on the memory storage;
a baseboard management controller (“BMC”); and
a local storage device, wherein the BMC performs stages comprising:
provisioning the DPU on the server, including configuring a portion of the local storage device of the server for DPU storage, the DPU storage including a DPU operating system (“OS”);
generating an encrypted access key;
encrypting access to the DPU storage with the encrypted access key;
providing the encrypted access key to the DPU firmware, wherein the DPU firmware is configured to delete the access key after accessing the DPU storage; and
retaining the encrypted access key in a secure storage location of the BMC.

2. The system of claim 1, the stages further comprising:
receiving instructions for performing a secure wipe of the DPU; and
in response to the instructions, deleting the encrypted access key.

3. The system of claim 2, the stages further comprising, in response to the instructions, causing the DPU to shut down.

4. The system of claim 1, the stages further comprising:
in an instance where the server reboots, receiving, from the DPU firmware, a request for the encrypted access key; and
providing the encrypted access key to the DPU firmware in response to the request, wherein the encrypted access is deleted by the DPU firmware after accessing the DPU storage.

5. The system of claim 1, wherein the encrypted access key is provided to the DPU firmware using a secure communication channel between a baseboard management controller and the DPU firmware.

6. The system of claim 1, wherein:
the DPU firmware persists on a flash memory of the DPU,
provisioning the DPU includes installing the DPU OS on the local storage device, and
the encrypted access key is used by the DPU firmware for unlocking access the DPU storage and launching the DPU OS.

7. The system of claim 1, wherein the encrypted access key is generated generating a sequence of bits using a random bit generator and encrypting the sequence of bits using an encryption algorithm.

8. A non-transitory, computer-readable medium containing instructions that, when executed by a hardware-based processor, causes the processor to perform stages for secure management of a data processing unit (“DPU”), the stages comprising:
provisioning a DPU on a server, including installing a DPU operating system (“OS”) on a portion of a storage device that does not support access restrictions with an encrypted access key;
generating an encrypted access key;
receiving, from a DPU firmware of the DPU, a request for the encrypted access key;
providing the encrypted access key to the DPU; and
retaining the encrypted access key in a secure storage location, wherein:
the encrypted access key is provided to the DPU OS by the DPU firmware,
access to DPU data at the storage device is locked by the DPU OS using the encrypted access key,
the encrypted access key is deleted by the DPU firmware after providing the encrypted access key to the DPU OS, and
the encrypted access key is deleted by the DPU OS after locking access to DPU data.

9. The non-transitory, computer-readable medium of claim 8, the stages further comprising:
receiving instructions for performing a security wipe; and
in response to the instructions, deleting the encrypted access key.

10. The non-transitory, computer-readable medium of claim 9, the stages further comprising, in response to the instructions, causing the DPU to shut down.

11. The non-transitory, computer-readable medium of claim 8, the stages further comprising:
in an instance where the server reboots, receiving, from the DPU firmware, a request for the encrypted access key; and
providing the encrypted access key to the DPU firmware in response to the request, wherein:
the encrypted access key is provided to the DPU OS by the DPU firmware,
the encrypted access key is deleted by the DPU firmware after providing the encrypted access key to the DPU OS,
the encrypted access is used by the DPU OS for accessing the DPU data, and
the encrypted access is deleted by the DPU OS after accessing the DPU data.

12. The non-transitory, computer-readable medium of claim 11, wherein the DPU OS is loaded by the DPU firmware in a secure boot mode, and the DPU firmware provides the encrypted access key to the DPU OS based on the DPU OS being loaded in the secure boot mode.

13. The non-transitory, computer-readable medium of claim 8, wherein the encrypted access key is provided to the DPU firmware using a secure communication channel between a baseboard management controller and the DPU firmware.

14. The non-transitory, computer-readable medium of claim 8, wherein the DPU firmware persists on a flash memory of the DPU.

15. A method for secure management of a data processing unit (“DPU”), comprising:
provisioning a DPU on a server;
configuring a portion of a media card connected to the server for DPU storage, the DPU storage including a DPU operating system (“OS”);
generating an encrypted access key;
providing the encrypted access key to DPU firmware of the DPU, wherein the DPU firmware locks access to the media card using the access key, wherein the DPU firmware is configured to delete the access key after locking access to the media card; and
retaining the encrypted access key in a secure storage location.

16. The method of claim 15, further comprising:
receiving instructions for performing a secure wipe of the DPU; and
in response to the instructions, deleting the encrypted access key.

17. The method of claim 16, further comprising, in response to the instructions, causing the DPU to shut down.

18. The method of claim 15, further comprising:
in an instance where the server reboots, receiving, from the DPU firmware, a request for the encrypted access key; and
providing the encrypted access key to the DPU firmware in response to the request, wherein the encrypted access is deleted by the DPU firmware after accessing the media card.

19. The method of claim 15, wherein the encrypted access key is provided to the DPU firmware using a secure communication channel between a baseboard management controller and the DPU firmware.

20. The method of claim 15, wherein:
the DPU firmware persists on a flash memory of the DPU,
provisioning the DPU includes installing the DPU OS on the media card, and
the encrypted access key is used by the DPU firmware for unlocking access the DPU storage and launching the DPU OS from the media card.
